(19) United States
(12) Patent Application Publication
(10) Pub. No.: US 2024/0141124 A1
(43) Pub. Date: May 2, 2024

(54) ULTRALOW DENSITY FIRE-RETARDANT FIBER COMPOSITE FOAM FORMED MATERIAL, PRODUCT AND MANUFACTURING METHOD THEREOF

(71) Applicant: AISTI CORPORATION OY, Jyväskylä (FI)

(72) Inventors: Mikko PAANANEN, Jyväskylä (FI); Antti FREDRIKSON, Jyväskylä (FI)

(21) Appl. No.: 18/546,731

(22) PCT Filed: Feb. 17, 2022
(86) PCT No.: PCT/EP2022/053967

§ 371 Date: Aug. 16, 2023

(30) Foreign Application Priority Data
Feb. 17, 2021 (FI) 20215161

(51) Int. Cl. C08J 9/00; C08J 9/14; C08J 9/228

(52) U.S. Cl. CPC C08J 9/0085; C08J 9/14; C08J 9/228; C08J 2401/08

(57) ABSTRACT

An ultralow density fire-retardant fiber composite foam formed material including at least 60-80% by weight of lignocellulosic fiber and/or regenerated cellulose fiber, and 0-10% by weight of foaming agent, wherein the material further includes an amount of weight of fire-retardant agent or wherein an amount of the cellulose and/or wood fiber has fire-retardant properties, wherein the fire growth index of the fiber composite is <120 W/s and the total heat release of the fiber composite is <7.5 MJ in accordance with Single Burning Item method (EN 13823), and wherein the density of the ultralow density fiber composite foam formed material is <150 kg/m³. Corresponding method of manufacture and products are also presented.

### FIELD OF THE INVENTION

The present invention generally relates to ultralow density fiber composites, which comprise lignocellulosic fibers. The present invention further concerns an ultralow density material having fire-retardant properties as well as a product and a method of manufacture thereof.

### BACKGROUND

Bio-based low-density materials offer renewable and biodegradable alternative to oil-based foam materials. Foam forming technology enables resource-efficient production of recyclable and sustainable materials including construction and packaging materials. Cellulose on the other hand is an abundant resource that is lightweight and affordable.

The manufacturing methods of cellulose fiber-based materials may be divided into wet, semi-dry and dry methods. Semi-dry and dry methods are suitable in the making of porous materials with low density, such as <100 kg/m³. In these methods, however, binding agents are needed in order to obtain adequate material strength. In wet methods, including water and foam forming, no binding agents are needed, since sufficient material strength is obtained through hydrogen bonding. However, water forming is not suitable for producing ultralow density materials with density <100 kg/m³. In foam forming, foaming agents are needed, and foaming agent residues remain in the material.

US2009068430 (Homatherm AG) concerns a wood-fiber heat-insulating material having a density of 30-300 kg/m³ and method of manufacture thereof. Material comprises 50-90% by weight of cellulose and/or wood fiber, 2-15% by weight fire-retardant agent and 5-30% by weight of binding agent (bico fibers). The manufacturing method comprises dry and semidry technologies.

WO2015066806 (FPInnovations) concerns a method for producing ultralow density fiber composite material having a density of 10-150 kg/m³. The method utilizes foam-forming technology and contains 0-30% by weight cellulose filaments, at least two additives such as a foaming agent, an adhesive, a sizing agent and a fire-resistant compound. The composite material is produced by continuous overflow foaming process.

WO2012006714 (FPInnovations et al.) concerns an ultralow density foam composite material having a density of 10-120 kg/m³ comprising >90% w/w natural fibers. The composite is prepared by a liquid forming process resulting in a three-dimensional reticular structure in which adhesion is achieved by hydrogen-bonds with the hydroxyl groups in the fiber. The composite comprises at least one surfactant and at least one co-polymer. The external co-polymer reacts with lignocellulosic material and forms a diffusion interphase or mechanical interlocking between the fibers. The composite material is produced by mold technique.

US2014000981 (Silfverhuth, E.) provides a low-density fireproof coating and a plate-like acoustic element comprising natural fibers, cellular plastic grains, mineral fillers, a binder, a fire-retardant and an anti-rot agent. A foaming agent may also be added to the material. Plastic cellular grains are utilized to achieve a density of 30-100 kg/m³ and thickness of up to 70 mm. Both open-cell and closed-cell plastic grains are used, and their proportion may be adjusted in accordance with desired acoustic properties.

One disadvantage of the related art is the need to use synthetic binders and/or chemicals to improve the material strength. For example, in US2009068430 and US2014000981 synthetic binders are used. WO2012006714 utilizes hydrogen bonding as a binding means but a base, such as ammonium hydroxide or sodium hydroxide, is needed.

One disadvantage of the related art is the need to use synthetic binders and/or chemicals to improve the material strength. The present invention also provides enhanced property combination for cellulose fiber based composite material.

### SUMMARY OF THE INVENTION

An objective of the present invention is to at least alleviate one or more problems arising from the limitations and disadvantages of the related art. The objective is achieved by various embodiments of an ultralow density fire-retardant fiber composite foam formed material, product and method of manufacture thereof.

Some advantages of the present invention include enhanced property combination for cellulose fiber based composite material. With the present disclosure it is possible to achieve a sufficient strength and fire-retardance to a porous ultralow density fiber composite foam formed material without the use of binders.

In accordance with an aspect of the present invention an ultralow density fire-retardant fiber composite foam formed material comprising at least
60-80% by weight of lignocellulosic fiber and/or regenerated cellulose fiber, and
0-10% by weight of foaming agent,
   wherein the material further comprises an amount of weight of fire-retardant agent or
   wherein an amount of the lignocellulosic fiber and/or regenerated cellulose fiber has fire-retardant properties, wherein the fire growth index of the fiber composite is <120 W/s and the total heat release of the fiber composite is <7.5 MJ in accordance with Single Burning Item method (EN 13823), and wherein the density of the ultralow density fiber composite foam formed material is <150 kg/m³.

In one embodiment the density of the foam formed material is <120 kg/m³. In another embodiment the density of the foam formed material is <100 kg/m³. In one embodiment the density of the foam formed material is >20 kg/m³. In one embodiment the density of the foam formed material is >40 kg/m³.

In one preferred embodiment, the foam formed material comprises <10% by weight foaming agent. In another embodiment the foam formed material comprises <5% by weight foaming agent. In a further embodiment the foam formed material comprises <1% by weight foaming agent.

In one embodiment, the foaming agent comprises sodium dodecyl sulfate, polyoxyethylene (20) sorbitan monolaureate, alkyl glucoside or alkyl polyglucoside, or a combination thereof.

In one embodiment, the foam formed material comprises fire-retardant agent selected from the group of phosphorus, potassium, boron, nitrogen, sulfur, silicon or mineral based fire-retardants, polymeric (halogen-containing) fire-retardants, chlorinated paraffins, organic salts or graphite-based fire-retardants, or a combination thereof.

In one preferred embodiment, the fire-retardant agent is on the surface of the material.

In one embodiment, the foam formed material comprises <10% by weight an additive to enhance compression and/or water resistance and/or bending strength. In another embodiment, the foam formed material comprises <5% by weight an additive. In further embodiment, the foam formed material comprises <2% by weight an additive.

In accordance with an aspect of the present invention a product comprising ultralow density fire-retardant fiber composite foam formed material of claim 1.

In accordance with an aspect of the present invention a method for producing an ultralow density fiber composite foam formed material, comprising the steps of:
feeding a fiber suspension and at least foaming agent into a foaming arrangement;
agitating the suspension and the at least foaming agent to produce the fiber foam, which fiber foam formation may be enhanced by sparging gas into the foaming arrangement;
discharging the fiber foam by pumping through a pipeline and a rectangular shape outlet in the forming arrangement to create a web; and
dosing an amount of fire-retardant agent into the fiber suspension, or fiber foam or to one or more surfaces of the web, or a combination of these.

In one embodiment drying the web above dry solid content of 80% and cutting it to sheets to form the product.

In one embodiment, the fire-retardant is added in the material, on one or more surfaces of the product or the product is coated or laminated by a fire-retardant-treated nonwoven, textile, paper or a felt on one or more product surfaces to create a fire-retardant coating on one or more product surfaces.

In one embodiment drying the web above a predetermined dry solid content value and cut it to sheets to form the product. In one embodiment the predetermined dry solid content value is 60-80%.

In one embodiment dosing an amount of fire-retardant agent to one or more surfaces of the product.

In accordance with an aspect of the present invention an ultralow density fire-retardant fiber composite foam formed product produced by the method of claim 16.

The term “foam forming”, also known as “foam laying”, refers here to any conventional technology in which water-fiber suspension is aerated with high intensive mixing and foaming agent.

The term “foam formed” material hence is a material/product, which has been produced by foam forming method.

The term “web” is used to refer to a continuous material, which has produced by foam forming method and which dry solid content is below 80%.

The term “fire-retardant” refers here to a chemical or filler added to a material to prevent the start of or slow the growth of fire. In this sense, the expressions “fire-retardant”, “fire-resistant” and “flame-retardant” may be used interchangeably.

The terms “lignocellulosic fiber” and “cellulosic fiber” may be used interchangeably in this disclosure.

Different embodiments of the present invention will become apparent by consideration of the detailed description.

### DETAILED DESCRIPTION OF THE DRAWINGS

Some exemplary embodiments of the present invention are reviewed more closely with reference to the attached drawings, wherein

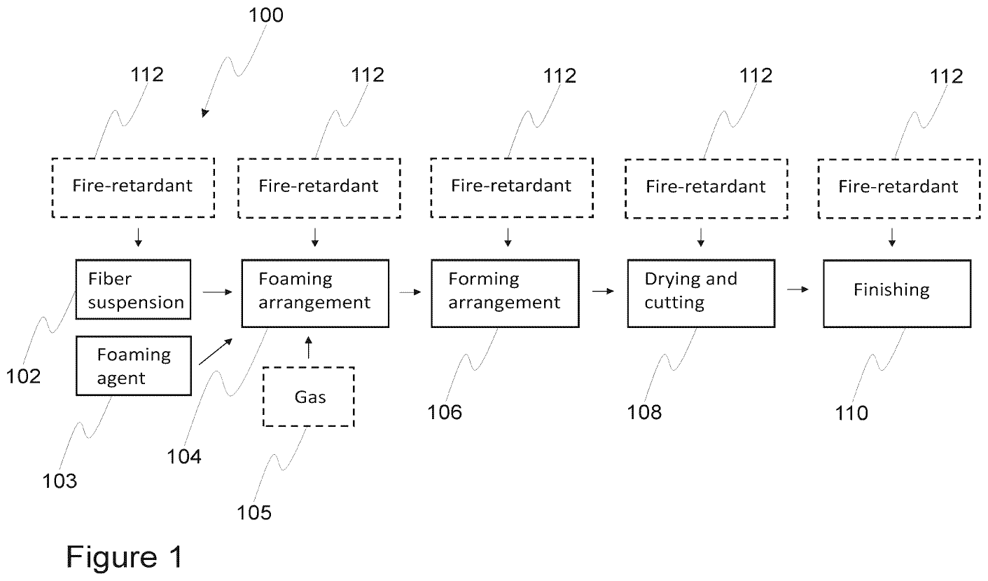

FIG. 1 illustrates an embodiment of the method in accordance with the present disclosure, and

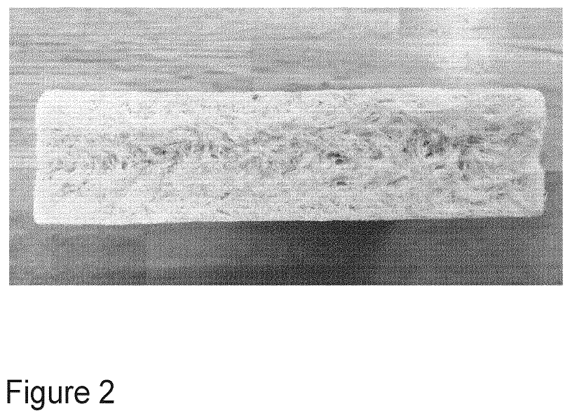

FIG. 2 illustrates an embodiment of the product in accordance with the present disclosure.

### DETAILED DESCRIPTION OF THE DISCLOSURE

Some detailed embodiments of the present invention are disclosed herein.

The ultralow density foam formed composite material comprises lignocellulosic fiber and/or regenerated cellulose fiber (60-80% by weight). The lignocellulosic fiber may comprise virgin wood fiber, paper pulp and natural fibers such as cotton, flax linen and hemp. Other suitable fiber sources include recycled fiber and side stream such as cutter and wood chips, saw dust and straw. Regenerated cellulose fiber may be for example viscose and lyocell fibers.

The material comprises fire-retardant agent (20-40% by weight). Some examples of suitable fire-retardant agents comprise phosphorus, potassium, boron, nitrogen, sulfur, silicon or mineral based fire-retardants, polymeric (halogen-containing) fire-retardants, chlorinated paraffins, organic salts or graphite-based fire-retardants, or a combination thereof.

The foaming agent is selected from anionic, non-ionic, cationic and zwitterionic foaming agents, or a combination thereof. Anionic foaming agent may be for example sodium dodecyl sulphate. Non-ionic foaming agent may be for example polyoxoethylene (20) sorbitan monolaureate or alkyl glucoside or alkyl polyglucoside. Foaming agent may also be a polymer like polyvinyl alcohol or protein-based agent.

The material may also comprise a functional additive to enhance the compression, bending strength and/or water resistance of the material. The additive may be selected from the group of nanocellulose, microcellulose, starch, alkyl ketene dimer, polyvinyl alcohol or latex, or a combination thereof.

The current European classification standard EN 13501-1 ranks construction materials in 7 classes with regard to their fire behavior: A1, A2, B, C, D, E and F. The standard also gives a classification of these products with regard to smoke development (s1, s2, s3) and the formation of flaming droplets/particles (d0, d1 and d2). In general, five different test methods are used to determine the classes. EN ISO 1182, EN ISO 1716, EN 13823, EN ISO 9239-1, EN ISO 11925-2.

Construction products (with the exception of floor coverings)
Class A1: EN ISO 1182 and EN ISO 1716
Class A2: EN ISO 1182 or EN ISO 1716 and EN 13823 (SBI)
Class B, C en D: EN 13823 (SBI) and EN ISO 11925-2
Class E: EN ISO 11925-2
Class F: Fire behaviour not determined

The current invention has the benefit to reach the classification B in accordance with the European classification standard.

FIG. 1 illustrates an embodiment of the method (100) in accordance with the present disclosure. A foaming arrangement or such system usable for the method may comprise at least a vessel/tank/container, which connects via a pipe or such conduit to a nozzle from which nozzle the material may be casted. First, a fiber suspension is prepared by mixing the lignocellulosic fibers with water (102). Foaming agent is then added into the suspension (103) and the mixture is mechanically mixed in a vessel/tank/container or a pipe/barrel, upon which a fiber foam is formed (104). Alternatively or additionally agitating the suspension and the at least foaming agent to produce the fiber foam may be enhanced by sparging gas into the foaming arrangement (105). The fiber foam is pumped through pipeline into a rectangular shape nozzle that distributes the fiber foam evenly on the wire, which is used to remove water with the help of gravitation and negative pressure (106). The removal of water may be enhanced by using heating units, such as infrared or microwave or hot air blowing. After the wire section, the web is transferred into a drying section and let to dry (108). Water is evaporated by using infrared, microwave or hot air blowing. After the drying section, the typical dry solids content of material is 80-95% or at least 60-80%. After the drying section the material is transferred to the cutting section (108). A fire-retardant agent is added on at least one surface of material before and/or after the cutting section by appropriate coating method like spray, film, foam or curtain coating (112). Alternatively, fire-retardant agent may be added to the suspension or fiber foam. Furthermore, fire-retardant treated nonwoven, felt, textile or paper may be finished by laminating on the surface of material after or before cutting phase (110).

An example of an ultralow density fire-retardant fiber composite foam formed product of the method is illustrated in FIG. 2.

The following examples are given to illustrate some embodiments and aspects of the present invention without limiting overall scope the invention.

### EXAMPLES

### Example 1—Manufacture of Foam Formed Materials

Material A

Surfactants Tween20 (dosage 8 g/l) and sodium dodecyl sulfate (dosage 4 g/l) were added into chemi-thermomechanical pulp-based fiber suspension (consistency 3%) and with highly intensive mixing fiber foam was prepared in a cylindrical tank. The mixing was continued until the air content of the fiber foam was 50%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium citrate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 90 kg/m³.

Material B

Surfactant Tween20 (dosage 6.5 g/l) was added into recycled cotton-based fiber suspension (consistency 2.7%) and with highly intensive mixing fiber foam was prepared in a cylindrical tank. The mixing was continued until the air content of the fiber foam was 45%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C. The final density of material was 75 kg/m³.

Material C

Surfactant Tween20 (dosage 6.5 g/l) was added into chemi-thermomechanical pulp (portion 50%) and recycled cotton (portion 50%) based fiber suspension (consistency 2.7%) and with highly intensive mixing fiber foam was prepared in a cylindrical tank. The mixing was continued until the air content of the fiber foam was 45%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C. The final density of material was 75 kg/m³.

Sound Absorption Properties

Sound absorption coefficients of the materials A, B and C were evaluated by impedance tube method according to standard ISO 10534-2. Tested sample diameter were 63 mm and the sample were mounted using an air cap of 180 mm behind the sample. The normal incidence sound absorption coefficients in 1/1-octave bands from 125 to 2000 Hz for materials are presented in Table 1.

TABLE 1
The normal incidence sound absorption coefficients in
1/1-octave bands from 125 to 2000 Hz for materials.

| | 125 Hz | 250 Hz | 500 Hz | 1000 Hz | 2000 Hz |
|---|---|---|---|---|---|
| Material A | 0.61 | 0.82 | 0.65 | 0.59 | 0.73 |
| Material B | 0.68 | 0.78 | 0.73 | 0.61 | 0.74 |
| Material C | 0.60 | 0.64 | 0.67 | 0.55 | 0.66 |

### Example 2—Manufacture of Foam Formed Materials

Material D

Surfactants Tween20 (dosage 0.3 g/l) and sodium dodecyl sulfate (dosage 0.3 g/l) were added into chemi-thermomechanical pulp-based fiber suspension (consistency 2.7%) and with highly intensive mixing fiber foam was prepared in a cylindrical tank. The mixing was continued until the air content of the fiber foam was 55%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium citrate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 85 kg/m³.

Material E

Starch, nanoclay and magnesium sulphate were added to chemi-thermomechanical pulp-based fiber suspension, which consistency was 3%. The dosage of starch was 1% of cellulose fiber weight, nanoclay 30% of cellulose fiber weight and magnesium sulphate 50% of cellulose fiber weight. After material dosage suspension was mixed about 1 min. Surfactants Tween20 (dosage 6.5 g/l) and sodium dodecyl sulfate (dosage 0.9 g/l) were added into suspension and with high intensive mixing fiber foam was prepared in a cylindrical tank. The mixing was continued until the air content of the fiber foam was 50%.

The fiber foam was poured into a mould with a wire bottom and drained by gravity until the dry matter content of fiber foam was approximately 10%. The wet fiber foam was removed from the mould on the wire to oven and the material was dried at 70° C.

Suspension contained potassium citrate based fire-retardant matter was sprayed on the both surfaces of the once-dried material. The dosage of fire-retardant was 15% of cellulose fiber weight on the both surfaces (total amount of sprayed fire-retardant was 30% of cellulose fiber weight). After spraying, the dry matter content of material was approximately 50%. Rewetted material was placed into a plastic bag and the moisture was let to even out in the material for 4 h. Finally, rewetted material was manually pressed between two plates with spacers to the 25 mm thickness and dried in an oven at 70° C. The final density of material was 80 kg/m³.

Material F

Surfactants Tween20 (dosage 0.3 g/l) and sodium dodecyl sulfate (dosage 0.3 g/l) were added into chemi-thermomechanical pulp-based fiber suspension (consistency 2.7%) and with highly intensive mixing fiber foam was prepared in a cylindrical tank. The mixing was continued until the air content of the fiber foam was 55%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium carbonate based fire-retardant matter was sprayed on the both surfaces of the material. The dosage of fire-retardant was 15% of cellulose fiber weight on the both surfaces (total amount of sprayed fire-retardant was 30% of cellulose fiber weight). After spraying, material was dried in an oven at 70° C. The final density of material was 97 kg/m³.

Material G

Surfactants Tween20 (dosage 0.3 g/l) and sodium dodecyl sulfate (dosage 0.3 g/l) were added into chemi-thermomechanical pulp-based fiber suspension (consistency 2.7%) and with highly intensive mixing fiber foam was prepared in a cylindrical tank. The mixing was continued until the air content of the fiber foam was 55%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium carbonate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 100 kg/m³.

Material H

Potassium carbonate based fire-retardant matter was added to chemi-thermomechanical pulp-based fiber suspension, which consistency was 3%. The dosage of fire-retardant was 50% of cellulose fiber weight. After material dosage suspension was mixed about 1 min. Surfactant Tween20 (dosage 6.5 g/l) was added into suspension and with high intensive mixing fiber foam was prepared in a cylindrical tank. The mixing was continued until the air content of the fiber foam was 50%.

The fiber foam was poured into a mould with a wire bottom and drained by gravity until the dry matter content of fiber foam was approximately 10%. The wet fiber foam was removed from the mould on the wire to oven and the material was dried at 70° C.

Suspension contained potassium carbonate based fire-retardant matter was sprayed on the both surfaces of the once-dried material. The dosage of fire retardant was 15% of cellulose fiber weight on the both surfaces (total amount of sprayed fire-retardant was 30% of cellulose fiber weight). After spraying, the dry matter content of material was approximately 50%. Rewetted material was placed into a plastic bag and the moisture was let to even out in the material for 4 h. Finally, rewetted material was manually pressed between two plates with spacers to the 20 mm thickness and dried in an oven at 70° C. The final density of material was 99 kg/m³.

Material I

Starch, nanoclay and magnesium sulphate were added to chemi-thermomechanical pulp-based fiber suspension, which consistency was 3%. The dosage of starch was 1% of cellulose fiber weight, nanoclay 30% of cellulose fiber weight and magnesium sulphate 50% of cellulose fiber weight. After material dosage suspension was mixed about 1 min. Surfactants Tween20 (dosage 6.5 g/l) and sodium dodecyl sulfate (dosage 0.9 g/l) were added into suspension and with high intensive mixing fiber foam was prepared in a cylindrical tank. The mixing was continued until the air content of the fiber foam was 50%.

The fiber foam was poured into a mould with a wire bottom and drained by gravity until the dry matter content of fiber foam was approximately 10%. The wet fiber foam was removed from the mould on the wire to oven and the material was dried at 70° C.

Suspension contained potassium carbonate based fire-retardant matter was sprayed on the both surfaces of the once-dried material. The dosage of fire-retardant was 15% of cellulose fiber weight on the both surfaces (total amount of sprayed fire-retardant was 30% of cellulose fiber weight). After spraying, the dry matter content of material was approximately 50%. Rewetted material was placed into a plastic bag and the moisture was let to even out in the material for 4 h. Finally, rewetted material was manually pressed between two plates with spacers to the 24 mm thickness and dried in an oven at 70° C. The final density of material was 94 kg/m³.

Material J

Surfactant Tween20 (dosage 6.5 g/l) was added into recycled cotton-based fiber suspension (consistency 2.7%) and with highly intensive mixing fiber foam was prepared in a cylindrical tank. The mixing was continued until the air content of the fiber foam was 45%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium citrate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 108 kg/m³.

Material K

Surfactant Tween20 (dosage 6.5 g/l) was added into chemi-thermomechanical pulp (portion 50%) and recycled cotton (portion 50%) based fiber suspension (consistency 2.7%) and with highly intensive mixing fiber foam was prepared in a cylindrical tank. The mixing was continued until the air content of the fiber foam was 45%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium citrate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 113 kg/m³.

Material L

Surfactant Tween20 (dosage 6.5 g/l) was added into recycled cotton-based fiber suspension (consistency 2.7%) and with highly intensive mixing fiber foam was prepared in a cylindrical tank. The mixing was continued until the air content of the fiber foam was 45%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium carbonate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 116 kg/m³.

Material M

Surfactant Tween20 (dosage 6.5 g/l) was added into chemi-thermomechanical pulp (portion 50%) and recycled cotton (portion 50%) based fiber suspension (consistency 2.7%) and with highly intensive mixing fiber foam was prepared in a cylindrical tank. The mixing was continued until the air content of the fiber foam was 45%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium carbonate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 124 kg/m³.

Material N

Surfactants Tween20 (dosage 0.3 g/l) and sodium dodecyl sulfate (dosage 0.3 g/l) were added into chemi-thermomechanical pulp-based fiber suspension (consistency 2.7%) and with highly intensive mixing fiber foam was prepared in a cylindrical tank. The mixing was continued until the air content of the fiber foam was 55%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium carbonate based fire-retardant matter was sprayed on the both surfaces of the material. The dosage of fire-retardant was 17.5% of cellulose fiber weight on the both surfaces (total amount of sprayed fire-retardant was 35% of cellulose fiber weight). After spraying, material was dried in an oven at 70° C. Finally, material surface towards the heat exposure was painted by calcium silicate-based paint (amount 186 g/m²). The final density of material was 108 kg/m³.

Fire-Retarding Properties

Fire-retarding properties of the materials D, E, F, G, H, I, J, K, L, M and N were evaluated by cone calorimetry method according to standard ISO 5660-1. Tested sample area was 10×10 cm and the utilized heat irradiance level was 50 kW/m². Measured maximum heat release rates (HRRₘₐₓ) for materials are presented in Table 2.

TABLE 2
Maximum heat release rates for materials D, E, F, G, H, I, J, K, L, M and N.

| Material | D | E | F | G | H | I | J | K | L | M | N |
|---|---|---|---|---|---|---|---|---|---|---|---|
| HRRₘₐₓ, | 85.1 | 80.1 | 56.9 | 47.5 | 64.3 | 62.9 | 96.8 | 81.9 | 60.7 | 71.2 | 84.7 |
| [kW/m²] | | | | | | | | | | | |

### Example 3—Manufacture of Foam Formed Material

Material O

Surfactants Tween20 (dosage 8 g/l) and sodium dodecyl sulfate (dosage 4 g/l) were added into chemi-thermomechanical pulp-based fiber suspension (consistency 3%) and with highly intensive mixing fiber foam was prepared in a cylindrical tank. The mixing was continued until the air content of the fiber foam was 50%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium citrate based fire-retardant matter was sprayed on the both surfaces of the material. The dosage of fire-retardant was 15% of cellulose fiber weight on the both surfaces (total amount of sprayed fire-retardant was 30% of cellulose fiber weight). After spraying, material was dried in an oven at 70° C. The final density of material was 80 kg/m³.

Material P

Surfactants Tween20 (dosage 8 g/l) and sodium dodecyl sulfate (dosage 4 g/l) were added into chemi-thermomechanical pulp-based fiber suspension (consistency 3%) and with highly intensive mixing fiber foam was prepared in a cylindrical tank. The mixing was continued until the air content of the fiber foam was 50%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium citrate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 90 kg/m³.

Material Q

Carboxymethyl cellulose and magnesium sulphate were added to chemi-thermomechanical pulp-based fiber suspension, which consistency was 3%. The dosage of carboxymethyl cellulose was 5% of cellulose fiber weight and magnesium sulphate 100% of cellulose fiber weight. After material dosage suspension was mixed about 1 min. Surfactants Tween20 (dosage 6.5 g/l) and sodium dodecyl sulfate (dosage 0.9 g/l) were added into suspension and with high intensive mixing fiber foam was prepared in a cylindrical tank. The mixing was continued until the air content of the fiber foam was 50%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 17 mm thickness and dried in an oven at 70° C.

Suspension contained potassium citrate based fire-retardant matter was sprayed on the both surfaces of the material. The dosage of fire-retardant was 15% of cellulose fiber weight on the both surfaces (total amount of sprayed fire-retardant was 30% of cellulose fiber weight). After spraying, material was dried in an oven at 70° C. The final density of material was 80 kg/m³.

Fire-Retarding Properties

Fire-retarding properties of the materials O, P and Q were evaluated by single burning item method according to standard EN 13823. In the method, test specimens, short wing 495 mm×1500 mm and long wing 1000 mm×1500 mm, are fixed cornerwise in the specimen holder of the test apparatus. Measured fire growth rate index (FIGRA) and total heat release (THR₆₀₀) for materials are presented in Table 3.

TABLE 3
Measured fire growth rate index (FIGRA) and total
heat release (THR₆₀₀) for materials O, P and Q.

| Material | O | P | Q |
|---|---|---|---|
| FIGRA, [W/s] | 93.5 | 93.6 | 69.9 |
| THR₆₀₀, [MJ] | 6.9 | 5.3 | 5.9 |

### Example 4—Manufacture of Foam Formed Material

Material R

Surfactants Tween20 (dosage 8 g/l) and sodium dodecyl sulfate (dosage 4 g/l) were added into chemi-thermomechanical pulp-based fiber suspension (consistency 3%) and with highly intensive mixing fiber foam was prepared in a cylindrical tank. The mixing was continued until the air content of the fiber foam was 50%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium citrate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 90 kg/m³.

Material S

Surfactant sodium dodecyl sulfate (dosage 0.6 g/l) were added into chemi-thermomechanical pulp-based fiber suspension (consistency 2%) and with highly intensive mixing fiber foam was prepared in a cylindrical tank. The mixing was continued until the air content of the fiber foam was 60%.

The fiber foam was poured into a mould with a wire bottom and drained by gravity until the dry matter content of fiber foam was approximately 10%. The wet fiber foam was removed from the mould on the wire to oven and the material was dried at 70° C. Once dried material was rewetted to dry matter content of 50% by spraying water on the both surfaces. Rewetted material was placed into a plastic bag and the moisture was let to even out in the material for 4 h. Finally, rewetted material was manually pressed between two plates with spacers to the 20 mm thickness and dried in an oven at 70° C.

Suspension contained potassium carbonate based fire-retardant matter was sprayed on the both surfaces of the material. The dosage of fire-retardant was 20% of cellulose fiber weight on the both surfaces (total amount of sprayed fire-retardant was 40% of cellulose fiber weight). After spraying, material was dried in an oven at 70° C. The final density of material was 100 kg/m³.

Volatile organic compound emissions of the materials R and S were evaluated by the emission chamber test method. Tested sample area was 0.25 m². Emission chamber test parameters and applied sampling and test methods are presented in Table 4 and Table 5. Emission test results after 28 days are presented in Table 6.

TABLE 4
Emission chamber test parameters.

| Parameter | Value | Parameter | Value |
|---|---|---|---|
| Chamber volume, V [m³] | 0.12 | Test period | 28 d |
| Air change rate, n [h⁻¹] | 0.5 | Area specific | 1.30 |
| | | ventilation rate, q | |
| | | [m/h or m³/m²h] | |
| Relative humidity of supply | 50 ± 5 | Loading factor | 0.4 |
| air, RH [%] | | [m²/m³] | |
| Temperature of supply air, | 23 ± 1 | Test scenario | Flooring or |
| T [° C.] | | | ceiling |

TABLE 5
Applied sampling and test methods.

| | | Quantification | | | |
|---|---|---|---|---|---|
| | | limit/ | | | Combined |
| | External | sampling | | Analytical | uncertainty |
| Procedure | method | volume | | principle | [RSD (%)] |
| Sample | M1 testing | — | | — | — |
| preparation | protocol | | | | |
| Emission | EN | — | | Chamber and air | — |
| chamber | 16516/2/, | | | control | |
| testing | ISO | | | | |
| | 16000-9/3/ | | | | |
| Sampling of | EN | 1.5-5 | L | Tenax TA | — |
| VOC | 16516/2/, | | | | |
| | ISO | | | | |
| | 16000-6/4/ | | | | |
| Analysis of | EN | 1 | μg/m³ | TD-GC/MS | ±25% |
| VOC | 16516/2/, | | | | |
| | ISO16000- | | | | |
| | 6/4/ | | | | |
| Sampling of | In-house | 200-400 | L | H₂SO₄ solution | — |
| formaldehydes | method/6/, | | | | |
| | EN 717- | | | | |
| | 1/7/ | | | | |
| Analysis of | In-house | 5 | μg/m³ | Spectrophotometry | ±23% |
| formaldehydes | method/6/, | | | | |
| | EN 717- | | | | |
| | 1/7/ | | | | |
| Sampling of | In-house | 200-400 | L | H₂SO₄ solution | — |
| ammonia | method/8/ | | | | |
| Analysis of | In-house | 5 | μg/m³ | Potentiometric ISE | ±33% |
| ammonia | method/8/ | | | | |

| | | | | |
|---|---|---|---|---|
| Odour/sensory | ISO | ISO | Odour panel | — |
| testing | 16000- | 16000- | | |
| | 28/9 | 28/9/ | | |

TABLE 6
Emission results for materials R and S.

Material

| | R | S |
|---|---|---|
| | Area specific | Area specific |
| | emission rate | emission rate |
| Parameter/Unit | mg/(m²h) | mg/(m²h) |
| TVOC | <0.006 | <0.006 |
| Formaldehyde | <0.005 | <0.007 |
| Ammonia | <0.005 | <0.011 |
| Total CMR [mg/m³] | <0.001 | <0.001 |
| Odour (dimensionless) | +0.9 | +0.8 |

The scope of the invention is determined by the attached claims together with the equivalents thereof. Persons skilled in the art will appreciate the fact that the disclosed embodiments were constructed for illustrative purposes only, and the innovative fulcrum reviewed herein will cover further embodiments, embodiment combinations, variations and equivalents that better suit each particular use case of the invention.

1. An ultralow density fire-retardant fiber composite foam formed material comprising at least
60-80% by weight of lignocellulosic fiber and/or regenerated cellulose fiber, and
0-10% by weight of foaming agent,
wherein the material further comprises an amount of weight of fire-retardant agent or wherein an amount of the lignocellulosic fiber and/or regenerated cellulose fiber has fire-retardant properties, wherein the fire growth index of the fiber composite is <120 W/s and the total heat release of the fiber composite is <7.5 MJ in accordance with Single Burning Item method (EN 13823), and wherein the density of the ultralow density fiber composite foam formed material is <150 kg/m3.

2. The ultralow density fiber composite foam formed material according to claim 1, wherein the density of the foam material is <120 kg/m3.

3. The ultralow density fiber composite foam formed material according to claim 1, wherein the density of the foam material is <100 kg/m3.

4. The ultralow density fiber composite foam formed material according to claim 1, wherein the density of the foam material is >20 kg/m3.

5. The ultralow density fiber composite foam formed material according to claim 1, wherein the density of the foam material is >40 kg/m3.

6. The ultralow density fiber composite foam formed material according to claim 1, comprising 20-40% by weight of fire-retardant agent.

7. The ultralow density fiber composite foam formed material according to claim 1, wherein the amount of foaming agent is <10% by weight.

8. The ultralow density fiber composite foam formed material according to claim 1, wherein the amount of foaming agent is <5% by weight.

9. The ultralow density fiber composite foam formed material according to claim 1, wherein the amount of foaming agent is <1% by weight.

10. The ultralow density fiber composite foam formed material according to claim 1, wherein the fire-retardant agent is phosphorus, potassium, boron, nitrogen, sulfur, silicon or mineral based fire-retardant, polymeric halogen containing retardant, chlorinated paraffin, organic salt or graphite-based fire-retardant, or a combination thereof.

11. The ultralow density fiber composite foam formed material according to claim 1, wherein the fire-retardant agent is on the surface of the material as a coating or the material is coated by the fire-retardant treated nonwoven, textile, paper or a felt.

12. The ultralow density fiber composite foam formed material according to claim 1, wherein the foaming agent is dodecyl sulfate, polyoxoethylene (20) sorbitan monolaureate or alkyl glucoside, alkyl polyglucoside or a combination thereof.

13. The ultralow density fiber composite foam formed material according to claim 1, comprising a functional additive selected from the group of nanocellulose, microcellulose, starch, alkyl ketene dimer, polyvinyl alcohol and latex to improve mechanical properties.

14. The ultralow density fiber composite foam formed material according to claim 1, wherein the amount of functional additive is <10% by weight.

15. The ultralow density fiber composite foam formed material according to claim 1, wherein the amount of functional additive is <5% by weight.

16. The ultralow density fiber composite foam formed material to claim 1, wherein the amount of functional additive is <2% by weight.

17. A product comprising the ultralow density fire-retardant fiber composite foam formed material of claim 1.

18. A method for producing an ultralow density fiber composite foam formed material, comprising the steps of:
feeding a fiber suspension and at least foaming agent into a foaming arrangement;
agitating the suspension and the at least foaming agent to produce the fiber foam, which fiber foam formation may be enhanced by sparging gas into the foaming arrangement;
discharging the fiber foam by pumping through a pipeline and a rectangular shape outlet in the forming arrangement to create a web; and
dosing an amount of fire-retardant agent into the fiber suspension, or fiber foam or to one or more surfaces of the web, or a combination of these.

19. The method of claim 18, further comprising drying the web above a predetermined dry solid content value and cutting the web into sheets to form the product.

20. The method of claim 18, wherein predetermined dry solid content value is 60-80%.

21. The method of claim 18, wherein dosing an amount of fire-retardant agent to one or more surfaces of the product.

22. The method of claim 18, wherein the fire-retardant is added in the material, on one or more surfaces of the web/product or the product is coated or laminated by a fire-retardant-treated nonwoven, textile, paper or a felt on one or more product surfaces to create a fire-retardant coating on one or more surfaces of the product.

23. An ultralow density fire-retardant fiber composite foam formed product produced by the method of claim 18.
